(19) United States
(12) Patent Application Publication
(10) Pub. No.: US 2005/0059491 A1
(43) Pub. Date: Mar. 17, 2005

(54) Method of data synchronization in multiplayer network games

(75) Inventor: Dong-Gweon Oh, Seoul (KR)

Correspondence Address: SUGHRUE MION, PLLC, 2100 PENNSYLVANIA AVENUE, N.W., SUITE 800, WASHINGTON, DC, 20037, US

(73) Assignees: TRIHEDRON CO., LTD; INSTITUTE OF INFORMATION TECHNOLOGY ASSESSMENT

(21) Appl. No.: 10/662,786

(22) Filed: Sep. 16, 2003

(51) Int. Cl. G06F 19/00

(52) U.S. Cl. 463/42

(57) ABSTRACT

Disclosed is a data synchronization method in multiplayer network games and a network game system using the same. The network game system includes a plurality of clients in which an application program for a P2P network game is operated to execute the network game according to game logic; and a game server for mediating the network game among the clients, in which the application program includes a game processing module that defines objects used in the game to execute the game and manages variations in attributes of the objects, and a communication module that takes charge of communication between the game server and the clients and among the clients and, when there is a variation in the attributes of the objects, extracts varied contents to transmit them in unit of packets to the clients participating in the game. The present invention processes communication functions of transmitting and receiving a variation in objects, which were performed by application in prior arts, using a separate module. Accordingly, data synchronization in network games can be achieved without increasing complexity of program.

The present invention relates to peer-to-peer on-line games and, more particularly, to a data synchronization method in multiplayer network games and a network game system using the same for the purpose of minimizing, through data synchronization, non-instantaneousness and non-reliability in data transmission due to physical limitations of networks.

### BACKGROUND ART

With the propagation of the Internet, Internet users who enjoy on-line network games using the Internet have been explosively increased. These network games are executed in such a manner that a game server in which a manager site is open intermediates between user's terminals (referred to as “clients” hereinafter) On-line network games require synchronization that simultaneously displays variations in characteristics of objects used in the games on the terminal screens of games users in order that the users may enjoy the games in real time. However, networking includes ‘non-reliability’ and ‘non-instantaneousness’ so that data packets transmitted between clients on the Internet may be lost without warning notice and reception of the data packets within a limited time is not guaranteed. Furthermore, since ‘reliability’ and ‘instantaneousness’ are closely connected with each other, one of them becomes problematical when the other one is excessively pursued.

It is impossible to completely eliminate the aforementioned problem because it is caused by physical limitations of networks. However, it is possible to hide the problem so as not to allow users to recognize it. For this, optimization techniques including dead reckoning technique using extrapolation and forward error correction technique is used.

However, these techniques should attach application logic to each of specific data fields loaded on data packets and separately process it. This makes the techniques sensitive to a variation in program versions and excessively increases complexity of program.

### DISCLOSURE OF INVENTION

Accordingly, the present invention has been made in view of the aforementioned problems, and it is an object of the present invention to provide a data synchronization method in multiplayer network games, comprising a first step of detecting data having a varied attribute from data constructing objects belonging to a first client according to logic of a game operated in the first client; and a second step of extracting varied contents of the detected data, segmenting the contents into packets, and transmitting the packets to a second client, wherein the first and second steps are carried out by modules independent of each other.

In the present invention, the first step discriminates the data having a varied attribute from data constructing the objects. The second step transmits the packets using at least one of dead reckoning technique, forward error correction technique, reliable transmission technique based on Negative Acknowledge (“NACK”) and reliable transmission technique based on Acknowledge (“ACK”) or a combination of these techniques. In addition, the second step makes the first and second clients share information about their objects to synchronization data of the first client with data of the second client.

The present invention also provides a system for peer-to-peer (“P2P”) network games, comprising a plurality of clients in which an application program for a P2P network game is operated to execute the network game according to game logic; and a game server for mediating the network game among the clients, wherein the application program includes a game processing module that defines objects used in the game to execute the game and manages variations in attributes of the objects, and a communication module that takes charge of communication between the game server and the clients and among the clients and, when there is a variation in the attributes of the objects, extracts varied contents to transmit them in unit of packets to the clients participating in the game.

In the present invention, each of the clients includes an object database (DB) for storing data constructing the objects, and the communication module makes the clients participating in the game share their object DBs to synchronize data of the clients. The communication module transmits packets using at least one of dead reckoning technique, forward error correction technique, reliable transmission technique based on NACK and reliable transmission technique based on ACK or a combination of these techniques.

### BRIEF DESCRIPTION OF THE DRAWINGS

Further objects and advantages of the invention can be more fully understood from the following detailed description taken in conjunction with the accompanying drawings, in which:

FIG. 1 is a schematic view showing the construction of a system for executing P2P network games according to the present invention; and

FIG. 2 is a schematic view showing the construction of a client according to the present invention.

### DETAILED DESCRIPTION OF THE INVENTION

The present invention will now be described in detail in connection with preferred embodiments with reference to the accompanying drawings.

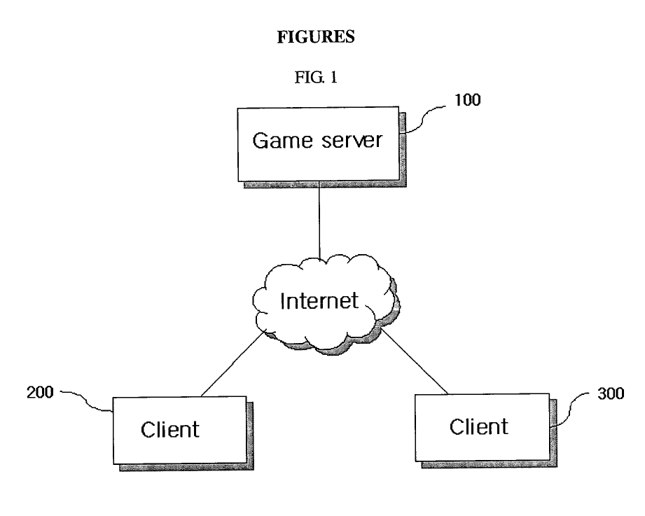

FIG. 1 schematically shows the construction of a system for executing P2P network games according to the present invention.

A game server 100 manages information about clients 200 and 300 participating in a game and their users and mediates P2P network games between the clients 200 and 300. For example, the game server 100 memorizes IP address of the client 200 and then transmits it to the client 300 who wants to play a game with the client 200 so that a P2P network game having the client 200 as a server can be executed.

Upon the operation of a program for the P2P network game, the clients 200 and 300 play the P2P network game according to a game logic. To play the game, the clients 200 and 300 synchronize data in such a manner that they generate and delete objects (tanks, for example) used in the game, detect variations in data constructing the objects (for example, position, direction, speed of a tank, direction of the gun barrel of the tank, firing time and direction, radio communication contents and so on) and transmit them to the counterpart clients 300 and 200.

For data synchronization, the clients 200 and 300 transmit data packets through optimization techniques that include the dead reckoning method using extrapolative forecasting that forecasts the future based on the principle of continuity, forward error correction technique, reliable transmission technique based on NACK, and reliable transmission technique based on ACK. The forward error correction technique transmits additional information in addition to data information to allow a receiving side to detect an error existing in data using the additional information and to correct it. These optimization techniques are widely being used in wired and wireless communications so that detailed explanation therefor is omitted.

To use the optimization techniques, application logic should be given to each of data fields loaded on data packets and separately processed. For this, the present invention separately operates functions of conventional application for network games.

Specifically, in order to synchronize a variation in characteristic of an object (movement of a tank, for example) that is generated in a certain client 200 with the counterpart client 300, the present invention separates a module (layer) that takes exclusive charge of communication-related operations, such as assembling and disassembling of data packets, transmission and retransmission of the data packets, and error data correction for informing the characteristic variation, from conventional application to separately operate the module.

The prevent applicant names the module that is exclusively responsible for the communication-related operations Nexus.

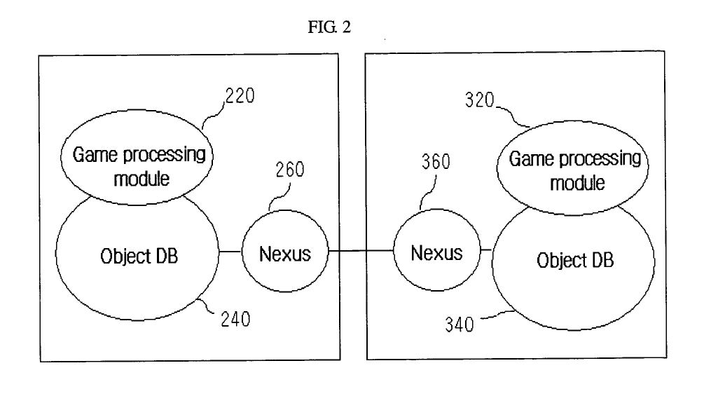

FIG. 2 schematically shows the construction of a client according to the present invention.

In the present invention, game application for executing a network game is operated, being divided into two modules (layers), that is, game processing modules 220 and 320 and Nexuses 260 and 360 corresponding to communication modules. The game processing modules 220 and 320 operate a corresponding game program in the clients 200 and 300, respectively. Nexuses 260 and 360 transmit data about variations in objects.

The game processing modules 220 and 320 define the objects used in the game according to game logic and manage variations in attributes of the objects. That is, the game processing modules 220 and 320 generate and delete the objects and, if required, correct the attributes of the objects or read the attribute values of the objects.

Object DBs 240 and 340 store data required for the game processing modules 220 and 320 to operate the network game, respectively.

Nexuses 260 and 360 make the clients 200 and 300 participating in the game share data about their objects to synchronize variations in the data in real time. Specifically, when Nexus 260 senses a variation in data constructing an object of the object DB 240, it detects which data item among the data constructing the object is varied and detects a degree of variation, disassembles the varied contents into packets, and then transmits the packets to the client 300. The Nexus 360 at the receiving side assembles the received packets to update corresponding data of corresponding object belonging to the client 300 so as to synchronize the client 300 with the client 200.

The receiving client displays the object constructed of varied data on the screen thereof.

The object DBs 240 and 340 store data constructing the objects used in the game. Each of the objects is constructed of attributes (parameters including the form, color, position, direction and size of an object) that define characteristics of the object. Each attribute value has time-dependency, reliability level, time-constraint, and persistency.

A data synchronization method in a game played by the clients 200 and 300 is explained below.

A preparatory procedure for executing the game is identical to that of a conventional network game so that explanation therefore is omitted.

In the case that the user of the client 200 discharges a cannon ball from his/her tank (object) so that a variation in the attributes of the object (tank) occurs While clients 200 and 300, remotely located, are playing a P2P network game, the game processing module 220 informs the object DB 240 of varied data (attribute) among data items constructing the tank.

For example, the tank can discharge the cannon ball with the direction of its gun barrel changed while moving. Otherwise, the tank can fire the cannon ball by varying only the gun barrel without being moved. In the latter case, there is no need to transmit data about the position of the tank for synchronization because the tank position is not changed.

Nexus 260 detects a degree of variation in corresponding data and transmits varied contents to Nexus 360 at the receiving side through a separate channel according to character of the data.

For example, Nexus 260 detects data about a moving distance and moving direction of the gun barrel of the tank, a direction and rapidity of fire of the cannon ball, segments the data into packets, and sends the packets to Nexus 360.

In prior arts, at this time, application logic is attached to each of data fields loaded on the data packets to separately process them in order to transmit the varied contents of the object. However, the present invention can carry out this operation using Nexus 260 to transmit the packets using one of the above-described optimization techniques without complicating the game operating program.

Nexus 360 at the receiving side assembles the packets received from Nexus 260 at the transmitting side to update the object DB 340 thereof.

That is, Nexuses 260 and 360 connect the object DBs 240 and 340 under their management to each other to form a kind of common space so that the clients 200 and 300 can synchronize variations in their objects with each other.

The game processing module 320 displays data assembled by the Nexus 360 on the screen of the client 300. Accordingly, the user of the client 300 can see the varied object, that is, the object synchronized with the object displayed on the screen of the client 200.

### INDUSTRIAL APPLICABILITY

As described above, the present invention processes communication functions of transmitting and receiving a variation in objects, which were performed by application in prior arts, using a separate module. Accordingly, data synchronization in network games can be achieved without increasing complexity of program.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A data synchronization method in multiplayer network games, comprising:
a first step of detecting data having a varied attribute from data constructing objects, according to logic of a game operated in a first client, said objects being belong to the first client; and
a second step of extracting varied contents of the detected data, segmenting the contents into packets, and transmitting the packets to a second client,
wherein the first and second steps are carried out by modules independent of each other.

2. The data synchronization method as claimed in claim 1, wherein the first step discriminates the data having a varied attribute from data constructing the objects.

3. The data synchronization method as claimed in claim 1, wherein the packets of the second step are transmitted using at least one of dead reckoning technique, forward error correction technique, reliable transmission technique based on negative acknowledge (NACK) and reliable transmission technique based on acknowledge (ACK) or a combination of these techniques.

4. The data synchronization method as claimed in claim 3, wherein the second step makes the first and second clients share information about their objects to synchronization data of the first client with data of the second client.

5. A system for peer-to-peer (P2P) network games, comprising:
a plurality of clients in which an application program for a P2P network game is operated to execute the network game according to game logic; and
a game server for mediating the network game among the clients,
wherein the application program includes a game processing module that defines objects used in the game to execute the game and manages variations in attributes of the objects, and a communication module that takes charge of communication between the game server and the clients and among the clients and, when there is a variation in the attributes of the objects, extracts varied contents to transmit them in unit of packets to the clients participating in the game.

6. The system as claimed in claim 5, wherein each of the clients includes an object database (DB) for storing data constructing the objects, and the communication module makes the clients participating in the game share their object DBs to synchronize data of the clients.

7. The system as claimed in claim 6, wherein the communication module transmits packets using at least one of dead reckoning technique, forward error correction technique, reliable transmission technique based on negative acknowledge (NACK) and reliable transmission technique based on acknowledge (ACK) or a combination of these techniques.
